(19) United States
(12) Patent Application Publication
(10) Pub. No.: US 2021/0078038 A1
(43) Pub. Date: Mar. 18, 2021

(54) MATERIALS AND METHODS FOR PASSIVE RADIATIVE COOLING

(71) Applicants: Jyotirmoy Mandal, Chittagong (BD); Yuan Yang, New York, NY (US); Yijun Chen, Hefei City (CN)

(72) Inventors: Jyotirmoy Mandal, Chittagong (BD); Yuan Yang, New York, NY (US); Yijun Chen, Hefei City (CN)

(73) Assignee: The Trustees of Columbia University in the City of New York, New York, NY (US)

(21) Appl. No.: 17/024,910

(22) Filed: Sep. 18, 2020

Related U.S. Application Data
(60) Provisional application No. 62/901,932, filed on Sep. 18, 2019.

(51) Int. Cl. B05D 5/06; B05D 7/00; C09D 7/20; C09D 7/61; C09D 127/20; C09D 133/08; C09D 133/10; C09D 7/40; C09D 5/33

(52) U.S. Cl. CPC B05D 5/063; B05D 5/066; B05D 7/544; C09D 7/20; C09D 7/61; C09D 127/20; C08K 3/22; C09D 133/10; C09D 7/67; C09D 5/004; B05D 2506/10; B05D 2601/10; B05D 2502/00; C09D 133/08

(57) ABSTRACT

A coating including a relatively thin visible-absorptive layer atop a relatively thick non-absorptive, solar-scattering underlayer. The thin top layer enables efficient absorption of appropriate visible wavelengths to show specific colors, and minimizes absorption in the infrared radiation in sunlight due to its relatively small thickness. Meanwhile, the bottom layer maximizes the backscattering of infrared light without absorption to reduce solar heating.

### CROSS REFERENCE TO RELATED APPLICATION(S)

This application claims the benefit of U.S. Provisional Application No. 62/901,932, filed Sep. 18, 2019, which is incorporated by reference as if disclosed herein in its entirety.

### BACKGROUND

Passive daytime radiative cooling (PDRC) is an eco-friendly way to cool objects under the sunlight without using electricity. Passive daytime radiative cooling (PDRC), a phenomenon where a surface reflects sunlight and radiates heat through the long wavelength infrared (LWIR) atmospheric window into the cold outer space, is a spontaneous, economical and eco-friendly way to cool objects under the sky. With global temperatures rising and energy scarcity problems requiring urgent solutions, PDRC is becoming an increasingly appealing alternative to air-conditioning, which is energy-consuming and has a net heating effect. Research on PDRC has yielded multiple designs, such as porous or metallized polymers, polymer-dielectric composites, photonic architectures and natural materials. Usually, these designs maximize radiative cooling by using metal mirrors or white materials with broadband solar reflectance (Rₛₒₗₐᵣ).

However, their high reflectance in visible wavelengths restricts their use in real-life situations. For instance, white colors are often not desirable as coatings on buildings or other objects for aesthetic or functional reasons. The high, broadband visible reflectance of existing PDRC solutions do not satisfy the aesthetic need for color and eye safety. Strong white or silvery glares from such PDRC designs can harm human eyes. Colored radiative coolers (CRCs), which selectively absorb parts of the visible spectrum (0.4-0.7 μm) while reflecting other solar wavelengths, in particular, near-to-short wavelength infrared (NSWIR, 0.7-3.0 μm) light and provide high thermal emittance have been explored to simultaneously achieve a high Rₛₒₗₐᵣ and colors. However, existing CRCs are limited either in their performance or their scope. For instance, multilayer photonic CRCs have high cooling performance, but currently are relatively expensive and difficult to fabricate for widespread usage on buildings or cars, which have various shapes, sizes, and textures. Colored paints based on TiO₂ particles and dye mixtures on the other hand, are scalable, but they often absorb excessive infrared and ultraviolet solar wavelengths to become hot under sunlight.

What is needed, therefore, is improved cooling performance with color maintained in a highly scalable manner.

### SUMMARY

Some embodiments of the present disclosure are directed to a coating for use on a surface including a colorant layer configured to selectively absorb one or more wavelengths of visible light, the colorant layer including one or more dyes, one or more pigments, one or more polymer binders, or combinations thereof and a scattering layer disposed beneath and separate from the colorant layer, the scattering layer configured to backscatter solar wavelengths of near infrared light and short-wavelength infrared light; and where the scattering layer has a thickness between about 1× greater and about 100× greater than that of the colorant layer.

In some embodiments, the thickness of the scattering layer is between about 1× greater and about 30× greater than that of the colorant layer. In some embodiments, the thickness of the scattering layer is between about 20× greater and about 30× greater than that of the colorant layer. In some embodiments, the scattering layer includes a porous polymer. In some embodiments, the colorant layer includes a porous polymer. In some embodiments, the porous polymer has a mean pore size between about 0.1 μm and about 50 μm. In some embodiments, the porous polymer includes poly(vinylidene fluoride-co-hexafluoropropene) or poly(methyl methacrylate). In some embodiments, the porous polymer includes poly(vinylidene fluoride-co-hexafluoropropene). In some embodiments, the colorant layer and the scattering layer include titanium dioxide, or silicon dioxide, or aluminum oxide, or combinations thereof.

In some embodiments, the colorant layer has an R_{VIS} greater than about 0.01 and an R_{NSWIR} greater than about 0.10. In some embodiments, the colorant layer has an R_{VIS} greater than about 0.01 and an R_{NSWIR} greater than about 0.30. In some embodiments, the colorant layer includes one or more pigments having a particle size less than about 100 nm. In some embodiments, the dyes, pigments, or polymers in the colorant layer exhibit minimal scattering of near infrared light and short-wavelength infrared light. In some embodiments, the colored layer has a matte finish or a glossy finish.

Some embodiments of the present disclosure are directed to a method for coating a surface including applying a first material comprising either at least one polymer and at least one liquid or a mixture comprising titanium dioxide, a polymer binder, and a liquid to the surface to form a scattering layer having an R_{NSWIR} greater than about 0.5; allowing the liquid in the scattering layer to evaporate; and applying a second material comprising at least one of a dye, pigment, polymer binder, or a combination thereof to the scattering layer to form a colorant layer.

In some embodiments, the at least one polymer comprises poly(vinylidene fluoride-co-hexafluoropropene) or poly(methyl methacrylate). In some embodiments the step of applying a first material further includes applying an amount of the first material such that the scattering layer has a thickness between about 1× greater and about 100× greater than that of the colorant layer. In some embodiments, the first material further comprises a solvent and wherein the liquid comprises water. In some embodiments, the step of allowing the liquid to evaporate comprises allowing the solvent and the liquid to evaporate so as to leave behind pores in the at least one polymer.

Some embodiments of the present disclosure are directed to a method for coating a surface including applying a first solution including at least one polymer and at least one of a solvent and a liquid non-solvent to the surface to form a scattering layer; allowing the at least one of the solvent and the liquid non-solvent in the scattering layer to evaporate, leaving behind pores in the at least one polymer; and applying a second solution including at least one of a dye, pigment, polymer binder, or a combination thereof to the scattering layer to form a colorant layer.

In some embodiments, the polymer includes poly(vinylidene fluoride-co-hexafluoropropene) or poly(methyl methacrylate). In some embodiments, the step of applying a first solution further includes applying an amount of the first solution such that the scattering layer has a thickness between about 1× greater and about 100× greater than that of the colorant layer.

In some embodiments, the first solution comprises a solvent and a liquid non-solvent, the solvent comprising acetone and the liquid non-solvent comprising water. In some embodiments, the second solution further comprises poly(vinylidene fluoride-co-hexafluoropropene).

Some embodiments of the present disclosure are directed to a kit for coating a surface, including a first solution including at least one polymer and at least one of a solvent and a liquid non-solvent; where the first solution is configured to form a scattering layer on the surface, the scattering layer comprising pores in the at least one polymer and configured to backscatter solar wavelengths of near infrared light and short-wavelength infrared light; a second solution including at least one of a dye, pigment, polymer binder, or a combination thereof; and where the second solution is adapted to form a colorant layer on top of the scattering layer, the colorant layer is configured to selectively absorb one or more wavelengths of visible light. Alternatively, the first solution can include a mixture including titanium dioxide pigment, a liquid, and a polymer binder.

In some embodiments, at least one polymer includes poly(vinylidene fluoride-co-hexafluoropropene). In some embodiments, the second solution includes poly(vinylidene fluoride-co-hexafluoropropene). In some embodiments, the first solution includes a solvent and a liquid non-solvent, the solvent comprising acetone and the liquid non-solvent comprising water. In some embodiments, the first solution includes a mixture including titanium dioxide pigment, a liquid, and a polymer binder. In some embodiments, the second solution further includes a solvent.

Some embodiments of the present disclosure include kit for coating a surface, including a first material comprising either at least one polymer and at least one a liquid or a mixture comprising titanium dioxide, a polymer binder, and a liquid; where the first solution is configured to form a scattering layer on the surface, the scattering layer is configured to backscatter solar wavelengths of near infrared light and short-wavelength infrared light and having an R_{NSWIR} greater than about 0.5; a second solution comprising at least one of a dye, pigment, polymer binder, or a combination thereof; and where the second solution is adapted to form a colorant layer on top of the scattering layer, the colorant layer is configured to selectively absorb one or more wavelengths of visible light.

In some embodiments, the first material includes a solution comprising at least one of poly(vinylidene fluoride-co-hexafluoropropene) and poly(methyl methacrylate), a solvent, and a liquid non-solvent. In some embodiments, the second solution includes poly(vinylidene fluoride-co-hexafluoropropene). In some embodiments, the solvent includes acetone and the liquid non-solvent comprising water. In some embodiments, the scattering layer includes pores in the at least one polymer.

Some embodiments of the present disclosure include a coating including a relatively thin visible-absorptive layer atop a relatively thick non-absorptive, solar-scattering porous poly(vinylidene fluoride-co-hexafluoropropene) (P(VdF-HFP)) or titanium dioxide underlayer. The thin top layer enables efficient absorption of appropriate visible wavelengths to show specific colors, and minimizes absorption in the infrared radiation in sunlight due to its small thickness. Meanwhile, the bottom layer maximizes the backscattering of infrared light with minimal absorption to reduce solar heating. Consequently, compared to monolayer commercial paint coatings with the same color but significant infrared absorption, the bilayer can achieve much higher infrared reflectances, which translate to significant temperature reductions under strong sunlight. This remarkable performance shows that bilayer designs according to some embodiments, which can be formed by a painting process, can achieve both color and efficient radiative cooling in a simple, inexpensive, and scalable way.

Without wishing to be bound by theory, to achieve cooling, a surface should maximize its solar reflectance Rₛₒₗₐᵣ to minimize solar heating. Color means that visible wavelengths complementary to the desired color are absorbed to some degree. However, other solar wavelengths, especially the near-to-short wavelength infrared (NSWIR, 0.7-3.0 μm) which do not contribute to color, may be reflected to maximize Rₛₒₗₐᵣ.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a cross section view of a coating according to a first embodiment of the present disclosure;

FIG. 2 is a schematic representation of the interaction between sunlight and thermal radiation in the first embodiment of the present disclosure;

FIG. 3 shows a schematic representation of a kit for coating a surface and a method for coating a surface according to some embodiments of the present disclosure;

FIGS. 4a-d show reflectance data obtained from two embodiments of the present disclosure and a monolayer design for comparison;

FIG. 5 is a schematic representation of an experimental test setup showing two embodiments of the present disclosure and a monolayer design for comparison;

FIGS. 6a-d show temperature data obtained from the experimental test setup shown in FIG. 5;

FIG. 7 shows images from an optical microscope and a scanning electron microscope of two embodiments of the present disclosure and a monolayer coating;

FIGS. 8a and 8b show views of an alternative embodiment of the present disclosure.

### DESCRIPTION

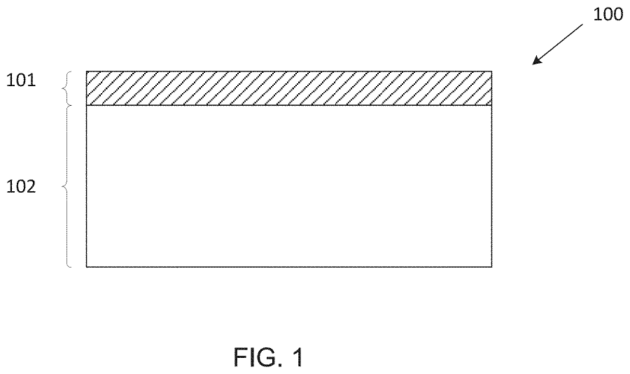

Referring now to FIG. 1, a coating 100 for use on a surface according to a first embodiment is shown. In this and some other embodiments, the coating 100 is a multilayer coating including two or more layers. In this embodiment, the coating 100 includes two layers: a colorant layer 101 and a scattering layer 102. The present disclosure utilizes the term “bilayer” to describe an exemplary embodiment including a top colorant and a bottom scattering layer, however the present disclosure is not limiting in this regard, as additional colorant, scattering, and/or other layers are included in other embodiments of the present disclosure.

In the embodiment shown in FIG. 1, the colorant layer 101 is a top layer and includes a colorant that selectively absorbs visible light. In some embodiments, the colorant layer 101 is configured to selectively absorb one or more wavelengths of visible light and comprises one or more dyes, one or more pigments, one or more polymer binders, or combinations thereof.

In this embodiment, the scattering layer 102 is disposed beneath and separate from the colorant layer 101. In this embodiment, the scattering layer 102 is configured to backscatter solar wavelengths of near infrared light and short-wavelength infrared light. In some embodiments, the coating 100 includes one or more solar scattering underlayers. In some embodiments, the scattering layer 102 has a thickness between about 1× greater and about 100× greater than that of the colorant layer 101. In some embodiments, the scattering layer has a thickness between about 1× greater and about 30× greater than that of the colorant layer 101. In some embodiments, the scattering layer has a thickness between about 20× greater and about 30× greater than that of the colorant layer 101.

In some embodiments, the colorant layer 101 absorbs visible wavelengths that are complementary to a desired color. In some embodiments, the colorant layer exhibits highly selective absorption of visible wavelengths. In some embodiments, the colorant layer exhibits minimal scattering of NSWIR wavelengths, which includes near infrared light and short-wavelength infrared light. In some embodiments, the dyes, pigments, or polymers in the colorant layer exhibit minimal scattering of near infrared light and short-wavelength infrared light. In some embodiments, the colorant layer comprises one or more pigments having a particle size less than about 100 nm. In other embodiments, the colorant layer comprises one or more pigments having a particle size less than about 75 nm, less than about 50 nm, less than about 20 nm, and less than about 10 nm. In some embodiments, minimal NSWIR scattering is achieved in the colorant layer by using pigments or organic dyes dissolved in polymers with such small particle sizes. In some embodiments, the colorant layer comprises any suitable color or combination of colors, e.g., black, red, blue, yellow, etc. In some embodiments, the colorant layer includes one or more commercial paints. In some embodiments, the colorant top layer, which has a concentrated colorant (for example, selectively visible absorbing black), ensures a strong, selective absorption of visible wavelengths that are incident or backscattered from the underlayer. In some embodiments, the colorant layer 101 has a reflectance of visible light (R_{VIS}) greater than about 0.01 and a reflectance of near to short wavelength infrared (R_{NSWIR}) greater than about 0.10. In some embodiments, the R_{NSWIR} of the colorant layer is greater than about 0.30 In some embodiments, the colorant layer includes a dye, pigment, or combinations thereof, such that the coating has an R_{VIS} greater than about 0.05 and an R_{NSWIR} greater than about 0.30.

As used herein, the reflectance R or R is defined as the ratio of the reflected solar intensity within a certain wavelength range (λ₁˜λ₂) to the total incident solar intensity in the same range, as expressed below:

$$\overline{R} = \frac{{\int }_{{λ}_{1}}^{{λ}_{2}} {I}_{solar} ( λ ) R ( λ ) d λ}{{\int }_{{λ}_{1}}^{{λ}_{2}} {I}_{solar} ( λ ) d λ}$$

where Iₛₒₗₐᵣ(λ) is the ASTM G173-03 Global solar intensity spectrum, R(λ) is the sample's spectral reflectance.

In some embodiments, the scattering underlayer 102 reflects sunlight in the NSWIR region of the spectrum. In some embodiments, the scattering layer 102 is configured to backscatter light having a wavelength between about 0.35 μm and about 2.5 In some embodiments, the scattering layer 102 includes one or more polymers. In some embodiments, the scattering layer 102 comprises poly(vinylidene fluoride-co-hexafluoropropene) (P(VdF-HFP)). In some embodiments, the scattering layer comprises poly(methyl methacrylate). In some embodiments, the scattering layer 102 is porous. In some embodiments, the scattering layer 102 comprises a porous polymer. In some embodiments, the porous polymer comprises poly(vinylidene fluoride-co-hexafluoropropene) or poly(methyl methacrylate). In some embodiments, the colorant layer comprises a porous polymer. In some embodiments, the porous polymer of the colorant layer comprises poly(vinylidene fluoride-co-hexafluoropropene) or poly(methyl methacrylate).

In some embodiments, the porous polymer of the scattering layer has a mean pore size between about 0.1 μm and about 50 μm. In some embodiments, the mean pore size is between about 0.1 μm and about 20 μm. In some embodiments, the mean pore size is between about 0.1 μm and about 15 μm. In some embodiments, the mean pore size is between about 0.1 μm and about 10 μm. In some embodiments, the mean pore size is between about 0.1 μm and about 5 μm. In some embodiments, the mean pore size is between about 0.7 μm and about 2.5 μm. In some embodiments, the mean pore size is between about 0.1 μm and about 0.5 μm.

In some embodiments, the scattering layer 102 includes titanium dioxide (TiO₂), silicon dioxide (SiO₂), aluminum oxide (Al₂O₃), or combinations thereof. In some embodiments, both the colorant layer 101 and the scattering layer 102 comprise TiO₂. In some embodiments, the scattering layer includes a TiO₂ based paint. Some embodiments of the disclosure include a bilayer design that is colorful while maintaining high radiative cooling performance, and can be applied like conventional paints.

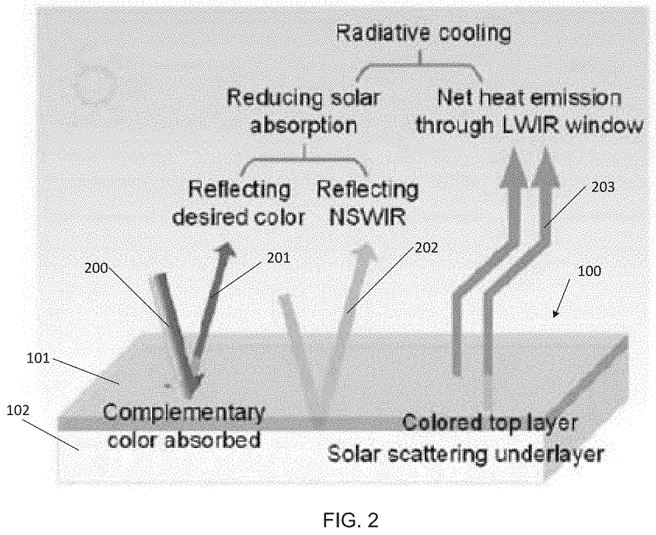

FIG. 2 shows a schematic representation of the interaction between sunlight and thermal radiation with the coating 100 of the embodiment shown in FIG. 1. Visible light 200 is incident on the colorant layer 101. The colorant layer 101 absorbs visible light having wavelengths complementary to the desired color of the coating. The desired color 201 is therefore the only visible light that is reflected. The scattering layer 102 reflects NSWIR 202. Absorption of solar wavelengths is therefore reduced. Further, because this embodiment utilizes a porous P(VdF-HFP) scattering layer, it has a high thermal emittance within the long wavelength infrared (LWIR) window. So there is significant heat emission 203 through the LWIR window.

Thus, a bilayer design according to some embodiments includes a thin, colored layer atop a thicker solar-scattering and non-absorptive underlayer. In some embodiments, the top layer has the same concentration of colorant and composition as a conventional monolayer with a certain target color, although commercial paints can include colorants that are NSWIR absorptive, and often pigments that scatter and absorb NSWIR wavelengths. Without wishing to be bound by theory, because the top layer is thin and scattering by the colorant is weak (if the colorants are nanoparticle pigments) or negligible (dissolved dye) for the NSWIR wavelengths, they are transmitted along short optical paths and without much absorption into the underlayer. Once in the solar-scattering underlayer, the NSWIR wavelengths are strongly backscattered without absorption into the top-layer, through which they pass mostly unimpeded into free space. Not only does this reduce unwanted NSWIR absorption, but also yields a vivid color using a thin layer of colorant. Furthermore, given that any organic dyes, pigments and polymer binders for the top layer are thermally emissive, c is not significantly impacted. The overall effect is enhanced cooling, with lowered colorant usage.

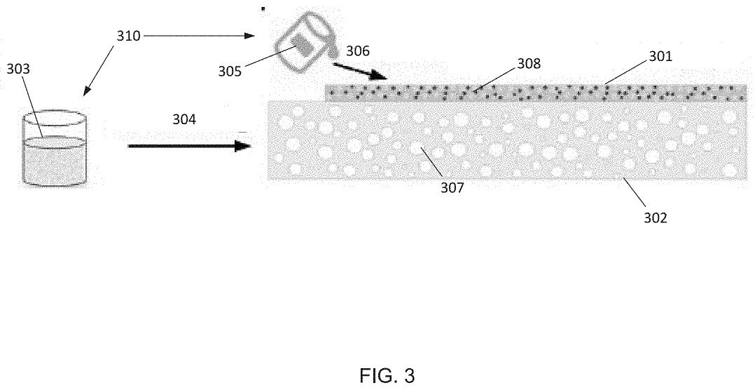

FIG. 3 shows a schematic representation of a kit 310 for coating a surface and a method for coating a surface according to some embodiments of the present disclosure. A first material 303 is applied (304) to a surface to form a scattering layer 302 having an R_{NSWIR} greater than about 0.5. In some embodiments, the first material 303 comprises at least one polymer and a liquid. In some embodiments, the first material 303 comprises a mixture comprising titanium dioxide, a polymer binder, and a liquid. As used herein, the terms “solvent” and “non-solvent” refer to compositions that are or are not solvents, respectively, for the polymer in the polymer solution. After application of the first layer, the liquid in the scattering layer is allowed to evaporate. Then, a second material 305 is applied 306 to the scattering layer 302. In some embodiments, the second solution 305 comprises at least one of a dye, pigment, polymer binder, or a combination thereof 308. The second solution forms a colorant layer 301.

In one embodiment of a kit 310 for coating a surface and a method for coating a surface according to some embodiments of the present disclosure, the first solution 303 comprises at least one polymer and at least one of a solvent and a liquid non-solvent. After application of the first layer, the at least one of the solvent and the liquid non-solvent in the scattering layer is allowed to evaporate, leaving behind pores 307 in the at least one polymer of which the scattering layer 302 is comprised.

As described previously, the scattering layer 302 formed by the first solution is configured to backscatter solar wavelengths of near infrared light and short-wavelength infrared light. The colorant layer 301 formed by the second solution is configured to selectively absorb one or more wavelengths of visible light. In some embodiments, the step of applying the first solution or material 303 further comprises applying an amount of the first solution or material such that the scattering layer has a thickness between about 1× greater and about 100× greater than that of the colorant layer.

In some embodiments, the at least one polymer in the first solution or material comprises poly(vinylidene fluoride-co-hexafluoropropene) or poly(methyl methacrylate). In some embodiments, the second solution or material also comprises poly(vinylidene fluoride-co-hexafluoropropene) or poly(methyl methacrylate). In some embodiments, the first solution or material comprises a solvent and a liquid non-solvent, where the solvent or material comprises acetone and the liquid non-solvent comprises water. In some embodiments, the second solution further comprises a solvent, and in other embodiments, comprises at least one of a solvent and a liquid non-solvent.

A kit according to one exemplary embodiment comprises a first solution comprising P(VdF-HFP) powder (Kynar Flex 2801), acetone (solvent), and water (liquid non-solvent) with a weight ratio of 1:8:1, respectively, and a second solution comprising Perylene Black (Oakwood Chemical) and P(VdF-HFP) dispersed in acetone in concentrations of 1 mg mL⁻¹ and 150 mg mL⁻¹ respectively. Other colors are used in other embodiments, including, but not limited to, commercial paints such as 2066-30 Big Country Blue, 2086-30 Rosy Blush, and 2021-30 Sunshine from Benjamin Moore®.

To create a bilayer colored cooler according to an embodiment of the present disclosure, a 2-step process according to an embodiment of the disclosure is employed. The first solution was applied (painted) on a plastic substrate to form a white layer with a thickness of ˜500 μm. The porous P(VdF-HFP) underlayer is thereby created using a phase inversion method. The volatile acetone rapidly evaporates leaving behind the water and polymer mixture. This mixture then phase separates, much like an oil and water mixture. This forms pores in the polymer as the micro-droplets of water evaporate. The layer containing the colorant is then painted on top of the scattering layer.

The pores that are left behind are good at both back-scattering sunlight and emitting thermal radiation back out to space. Some embodiments of this coating can reflect up to 98% of incoming sunlight, including infrared, visible, and ultraviolet wavelengths. This is more than typical white paint which only reflects about 80% of incoming visible light, while still absorbing building-heating IR and UV rays.

Certain embodiments of the present disclosure were tested alongside monolayer commercial paints of the same colors, which were both fabricated by a simple painting method. Specifically, two embodiments of solar-scattering underlayers were investigated. The first was a 500 μm thick layers of ˜50% porous P(VdF-HFP), which included interconnected micro- and nanopores, leading to highly efficient backscattering of sunlight. The second embodiment tested was 250 μm nonporous TiO₂-based white paint coating. The solid volumes per area in the two samples were the same. To ensure a fair comparison (i.e. near-indistinguishable visible appearance), the same thickness of solid commercial paints was used as the top-layer of our bilayer design and the monolayer. In these tests, the commercial paints used were: Perylene Black (Oakwood Chemical) 2066-30 Big Country Blue, 2086-30 Rosy Blush, and 2021-30 Sunshine from Benjamin Moore®.

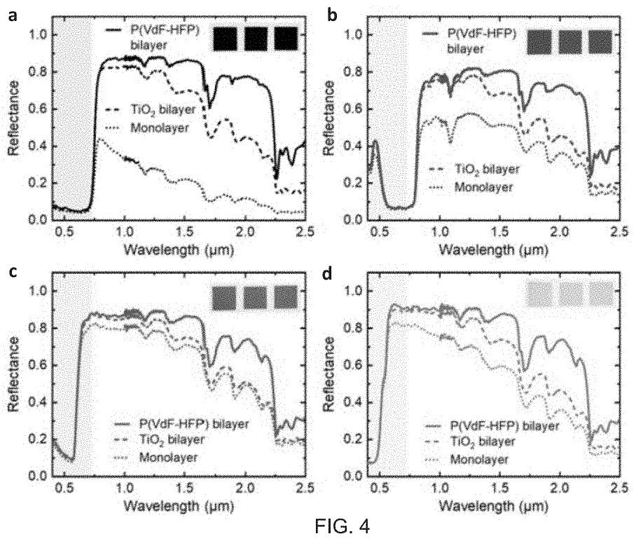

When compared to commercial monolayer paints, the two bilayer designs show near-identical colors, but with a significantly higher R_{NSWIR} (FIGS. 4a-d). FIGS. 4a-d show measured reflectance v. wavelength for each of the colors used in the tests: black FIG. 4a, blue FIG. 4b, red FIG. 4c, and yellow FIG. 4d. In each plot, the solid line is the P(VdF-HFP) bilayer, the dashed line is the TiO₂ bilayer, and the dotted line is the monolayer. These plots show that the visible spectrum for the mono- and bilayers of each color are closely matched, leading to similar CIE x and y chromaticity values and small lightness differences (See, from U.S. Prov. Pat. Appl. No. 62/901,932, the entirety of which is incorporated by reference herein: FIG. 3b, Supplementary FIG. 3, and Table 51).

In the NSWIR wavelengths shown in FIGS. 4a-d, however, the reflectances are significantly higher for the porous P(VdF-HFP)-based bilayers, followed by that of the TiO₂-based bilayers. Specifically, R_{NSWIR} increases from 0.43/0.74/0.69/0.30 in black/blue/red/yellow commercial monolayers to 0.58/0.79/0.80/0.73 and 0.63/0.84/0.86/0.81 in TiO2 and porous P(VdF-HFP)-based bilayer coating, respectively (Table 1).

TABLE 1
The reflectance values of the colored cooling coatings in visible (0.4-0.74 μm,
R_{VIS}) and NSWIR regions (0.74-2.5 μm, R_{NSWIR}). P, T and M correspond to
the porous P(VdF-HFP)-based bilayer, TiO₂-based bilayer and monolayer.

| | Black | | | Blue | | | Red | | | Yellow | | |
|---|---|---|---|---|---|---|---|---|---|---|---|---|
| Sample | P | T | M | P | T | M | P | T | M | P | T | M |
| R_{VIS} | 0.07 | 0.06 | 0.05 | 0.17 | 0.17 | 0.15 | 0.39 | 0.38 | 0.35 | 0.59 | 0.58 | 0.54 |
| R_{NSWIR} | 0.81 | 0.73 | 0.30 | 0.63 | 0.58 | 0.43 | 0.84 | 0.79 | 0.74 | 0.86 | 0.80 | 0.69 |

Without wishing to be bound by theory, the difference between the porous P(VdF-HFP) and TiO₂-based bilayers, meanwhile, is mainly due to the superior NSWIR scattering by the large micropores of P(VdF-HFP) compared to those by small TiO₂ pigments. Porous P(VdF-HFP), therefore, is an excellent choice for the bottom scattering layer in some embodiments. In addition to the high R_{NWSIR}, the bilayer CRC also maintains a high thermal emittance of between about 0.93 to about 0.96 within the LWIR window (See Supplementary FIG. 4 from U.S. Prov. Pat. Appl. No. 62/901,932) due to the intrinsically emissive nature of the top and bottom layer.

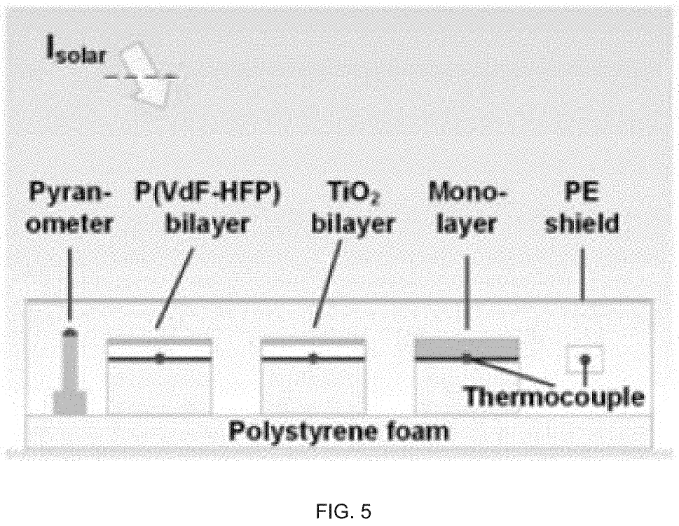

The enhancements in R_{NSWIR} in some embodiments of the present disclosure lead to better daytime cooling performances. To demonstrate this, the above bilayer and monolayer samples of each color were exposed to direct sunlight. FIG. 5 shows a schematic representation of the setup of this test. For each color, porous P(VdF-HFP)-based bilayer, TiO₂-based bilayer and monolayer samples with 7.5 cm×7.5 cm area were placed in a transparent open-top polycarbonate box. Solar and infrared transparent 25 μm-thick poly(ethylene) (PE) film was tautly drawn above the samples as a wind shield to reduce the convective heat transfer without significantly hindering solar and thermal infrared transmission. Samples were supported by polystyrene foams, and the box itself was placed on another large white polystyrene foam to reduce the heat transfer between the samples and ground. The temperature of each sample was measured by a thermocouple pressed to its back face by a black tape, which also served as a solar absorptive layer. A thermocouple shielded from sunlight was used to measure air temperature in the box. A pyranometer (Apogee, SP 510) connected to the computer was placed beside the sample to measure the total (direct+diffuse) solar intensity.

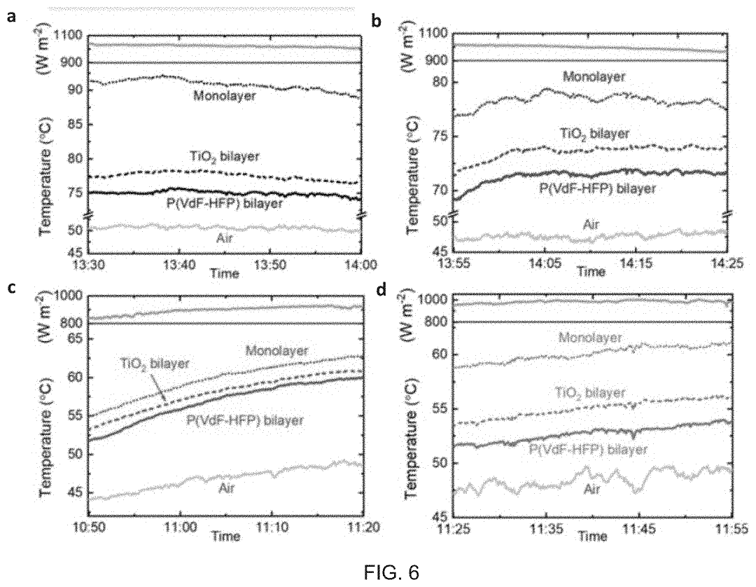

FIGS. 6a-d show plots of the temperature over time for the colored samples: black FIG. 6a, blue FIG. 6b, red FIG. 6c, and yellow FIG. 6d. For the extreme case—the black samples—due to the large contrast in R_{NSWIR} (0.81 for porous P(VdF-HFP) bilayer, 0.73 for TiO₂ bilayer and 0.30 for monolayer, (see Table 1), the porous P(VdF-HFP) and TiO₂-based bilayers are 15.6 and 13.2° C. cooler than the monolayer under ˜1025 W m⁻² solar irradiation (FIG. 4b). For blue/red/yellow colors, on the other hand, the porous P(VdF-HFP) and TiO₂-based bilayers are 6.6/3.0/7.3 and 4.3/1.8/5.2° C. cooler than the monolayer commercial paints (FIG. 4c-e), respectively. Such large temperature differences are consistent with simulation results (Supplementary Note 2, Supplementary FIG. 5 in U.S. Prov. Pat. Appl. No. 62/901,932), assuming a convective heat transfer coefficient (h_{c}) of ˜5-7 W m⁻² K⁻¹ observed in the literature. These results demonstrate that some embodiments of the current disclosure, especially based on porous P(VdF-HFP), are attractive for reducing temperatures and air-conditioning costs in buildings, cars and other terrestrial objects. More importantly from a practical perspective, the performances are achieved with a simple painting process, while satisfying the aesthetic requirement for color.

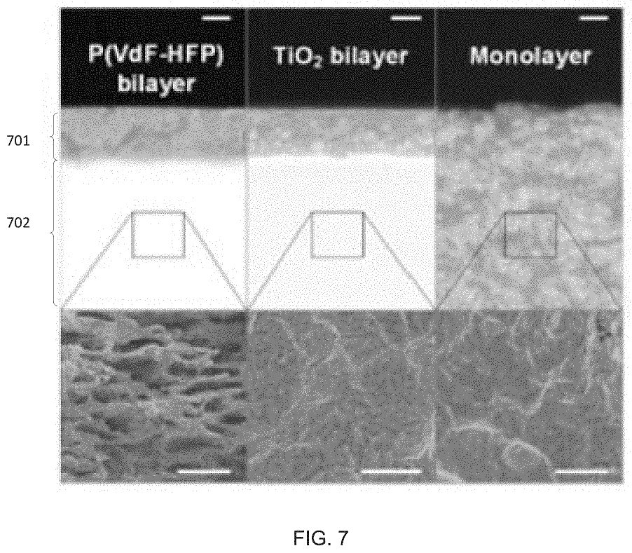

FIG. 7 shows images from an optical microscope and a scanning electron microscope of two embodiments of the present disclosure and a monolayer coating. The top row of images are from an optical microscope. They show a relatively thin red colorant layer 701 and a thicker scattering layer 702 in the bilayer embodiments. The bottom row of images were obtained using a scanning electron microscope. The pores in the P(VdF-HFP) scattering layer are shown in the respective SEM image.

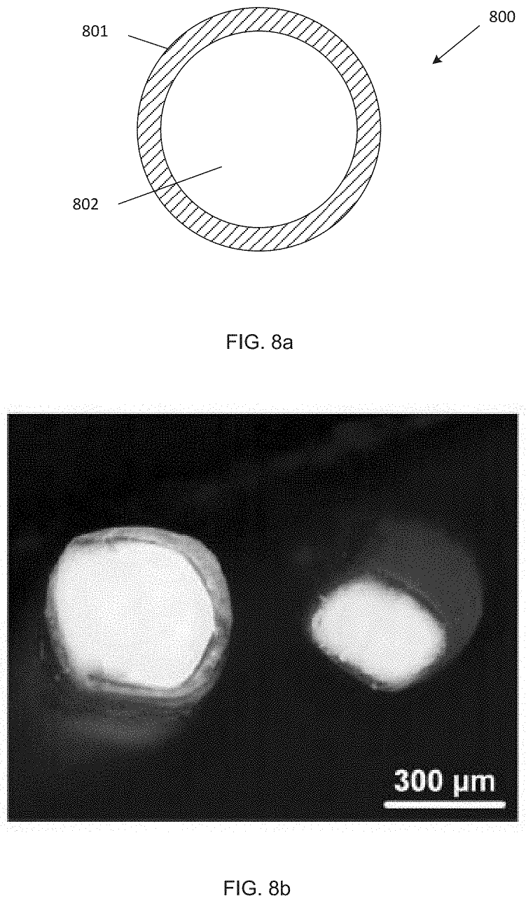

FIG. 8a shows another embodiment of the present disclosure, comprising a cross-sectional view of a fiber 800. A core 802 of a white polymer fiber includes a shell 801 formed by dipping the core 802 into a dye suspension. In this embodiment, the core 802 comprises porous P(VdF-HFP). The shell 801 also comprises porous P(VdF-HFP), but with a colorant added. Fiber 800 provides high solar reflectance and may be woven into clothing, tarpaulins, or other fabric-based items. In other embodiments, tarpaulin-like sheets are formed with a design similar to the coating shown in FIG. 1, as well as with a colorant layer on both sides of the scattering layer. FIG. 8b shows a photograph of exemplary fibers having a core and shell according to this embodiment.

Thus, methods, systems, and materials according to some embodiments of the present disclosure advantageously provide a paintable bilayer coating that can simultaneously achieve vivid colors and efficient radiative cooling, and can be applied like conventional paints and reduce usage of colorants in paints. The bilayer design according to some embodiments can achieve color, like commercial paints, but can efficiently reflect the invisible infrared part of sunlight than the latter. Typical scattering media often see significantly shallower penetration by shorter, visible wavelengths of sunlight than by longer, NSWIR wavelengths. Consequently, thick paint coatings are needed to achieve a high R_{NSWIR}. However, this also leads to an overuse of colorants, as visible light may not reach those deep within the coating. Further, even when they are selectively absorptive in the visible wavelengths, colorants have at least a trailing NSWIR absorptivity. Consequently, when dispersed within a scattering medium (e.g., TiO₂ based paints), they can still strongly absorb NSWIR wavelengths due to long optical paths of scattered light, lowering R_{NSWIR} and reducing PDRC capability.

The performance of some embodiments of the present disclosure, especially some embodiments that include P(VdF-HFP)-based bilayers, is improved over monolayer commercial paints. Under strong sunlight, this results in lowered temperatures (sometimes up to 15 degrees Celsius, depending on the color). By tuning the colorant components and amount, the R_{NWSIR} and color shades of some embodiments of the disclosure can be further controlled. Some embodiments demonstrate a simple, inexpensive, and scalable method to make a paintable colored radiative coating addressing both aesthetic and cooling requirements.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A coating for use on a surface, the coating comprising:
a colorant layer configured to selectively absorb one or more wavelengths of visible light, the colorant layer comprising one or more dyes, one or more pigments, one or more polymer binders, or combinations thereof; and
a scattering layer disposed beneath and separate from the colorant layer, the scattering layer configured to backscatter solar wavelengths of near infrared light and short-wavelength infrared light;
wherein the scattering layer has a thickness between about 1× greater and about 100× greater than that of the colorant layer.

2. The coating according to claim 1, wherein the thickness of the scattering layer is between about 20× greater and about 30× greater than that of the colorant layer.

3. The coating according to claim 1, wherein the scattering layer comprises a porous polymer.

4. The coating according to claim 3, wherein the colorant layer comprises a porous polymer.

5. The coating according to claim 4, wherein the porous polymer has a mean pore size between about 0.1 μm and about 50 μm.

6. The coating according to claim 5, wherein the porous polymer comprises poly(vinylidene fluoride-co-hexafluoropropene) or poly(methyl methacrylate).

7. The coating according to claim 1, wherein the colorant layer and the scattering layer comprise titanium dioxide, silicon dioxide, aluminum oxide, or combinations thereof.

8. The coating according to claim 1, wherein the colorant layer has an R_{VIS} greater than about 0.01 and an R_{NSWIR} greater than about 0.10.

9. The coating according to claim 1, wherein the colorant layer comprises one or more pigments having a particle size less than about 100 nm.

10. The coating according to claim 1, wherein the dyes, pigments or polymers in the colorant layer exhibit minimal scattering of near infrared light and short-wavelength infrared light.

11. A method for coating a surface, comprising:
applying a first material comprising either at least one polymer and at least one liquid or a mixture comprising titanium dioxide, a polymer binder, and a liquid to the surface to form a scattering layer having an R_{NSWIR} greater than about 0.5;
allowing the liquid in the scattering layer to evaporate; and
applying a second material comprising at least one of a dye, pigment, polymer binder, or a combination thereof to the scattering layer to form a colorant layer.

12. The method according to claim 11, wherein the at least one polymer comprises poly(vinylidene fluoride-co-hexafluoropropene) or poly(methyl methacrylate).

13. The method according to claim 12, wherein the step of applying a first material further comprises applying an amount of the first material such that the scattering layer has a thickness between about 1× greater and about 100× greater than that of the colorant layer.

14. The method according to claim 12, wherein the first material further comprises a solvent and wherein the liquid comprises water.

15. The method according to claim 14, wherein the step of allowing the liquid to evaporate comprises allowing the solvent and the liquid to evaporate so as to leave behind pores in the at least one polymer.

16. A kit for coating a surface, comprising:
a first material comprising either at least one polymer and at least one a liquid or a mixture comprising titanium dioxide, a polymer binder, and a liquid; and
wherein the first solution is configured to form a scattering layer on the surface, and the scattering layer is configured to backscatter solar wavelengths of near infrared light and short-wavelength infrared light and having an R_{NSWIR} greater than about 0.5;
a second solution comprising at least one of a dye, pigment, polymer binder, or a combination thereof; and
wherein the second solution is adapted to form a colorant layer on top of the scattering layer, the colorant layer is configured to selectively absorb one or more wavelengths of visible light.

17. The kit according to claim 16, wherein the first material comprises a solution comprising at least one of poly(vinylidene fluoride-co-hexafluoropropene) and poly(methyl methacrylate), a solvent, and a liquid non-solvent.

18. The kit according to claim 17, wherein the second solution comprises poly(vinylidene fluoride-co-hexafluoropropene).

19. The kit according to claim 17, wherein the solvent comprises acetone and the liquid non-solvent comprising water.

20. The kit according to claim 16, wherein the scattering layer comprises pores in the at least one polymer.
